(19) United States
(12) Patent Application Publication
(10) Pub. No.: US 2025/0078106 A1
(43) Pub. Date: Mar. 6, 2025

(54) PRICE SETTING SYSTEM, PRICE SETTING METHOD, AND COMPUTER-READABLE MEDIUM

(71) Applicant: NEC Corporation, Minato-ku, Tokyo (JP)

(72) Inventors: Yuki Seto, Tokyo (JP); Fumiya Igarashi, Tokyo (JP); Huiyu Zhang, Tokyo (JP); Haruka Sato, Tokyo (JP); Yusuke Miyamoto, Tokyo (JP); Yoshiaki Kubota, Tokyo (JP)

(73) Assignee: NEC Corporation, Minato-ku, Tokyo (JP)

(21) Appl. No.: 18/723,942

(22) PCT Filed: Jan. 21, 2022
(86) PCT No.: PCT/JP2022/002265

§ 371 Date: Jun. 25, 2024

(51) Int. Cl. G06Q 30/0201; G06Q 30/0202; G06Q 30/0283

(52) U.S. Cl. CPC G06Q 30/0206; G06Q 30/0202; G06Q 30/0283

(57) ABSTRACT

A price setting system receives demand data indicating a demand of a service in time series, the demand data being generated based on data indicating at least one action of reservation, purchase, and payment performed by a customer for the service. The price setting system determines predetermined accompanying data for the demand data. The price setting system sets a price for the service at a predetermined target time based on the demand data and the predetermined accompanying data.

### TECHNICAL FIELD

The present disclosure relates to a price setting system, a price setting method, and a program.

### BACKGROUND ART

Services such as accommodation services in hotels and inns are used by customers at prices set by service providers. This price can be set based on the supply and demand balance.

For example, Patent Literature 1 describes an accommodation rate setting apparatus for the purpose of setting an appropriate accommodation rate in an accommodation facility. The accommodation rate setting apparatus described in Patent Literature 1 includes an index calculation unit, a base price setting unit, and an accommodation rate setting unit. The index calculation unit estimates a supply index indicating a daily supply amount of the accommodation facility and a demand index indicating a daily demand for the accommodation facility in a predetermined period. The base price setting unit sets the base price of the accommodation rate based on the ratio of the supply index and the demand index on the first date in the future. The accommodation rate setting unit sets the accommodation rate on the future first date by causing the machine learning model to verify the set base price.

In addition, in the technique described in Patent Literature 1, the machine learning model is caused to determine whether to increase, maintain, or lower an accommodation rate for a day on which an external factor such as an economic situation, presence or absence of an event, an accommodation rate of a competing accommodation facility, or a reservation status of a competing accommodation facility occurs. Then, in the technique described in Patent Literature 1, a case where the result of the determination is similar to the ideal booking curve is determined to be correct, and other cases are determined to be incorrect.

### CITATION LIST

### Patent Literature

Patent Literature 1: Japanese Unexamined Patent Application Publication No. 2019-074988

### SUMMARY OF INVENTION

### Technical Problem

However, in the technique described in Patent Literature 1, the machine learning model only considers the external factors described above, and does not consider the sudden occurrence of the accommodation reservation due to circumstances on the customer side, and uniformly treats the past data. For this reason, there is a possibility that an appropriate price cannot be set.

Therefore, it is desired to develop a system capable of setting an appropriate price even when there is an exceptional demand due to circumstances on the customer side in the past data that is a basis for price setting for accommodation services in hotels or inns.

In addition, similar problems may occur not only in accommodation services in hotels and inns but also in various services. Therefore, it is desired to develop a system capable of setting an appropriate price for various services even when there is an exceptional demand due to circumstances on the customer side in the past data that is a basis for price setting.

The present disclosure has been made to solve the above-described problems, and an object thereof is as follows. That is, it is an object of the present disclosure to provide a price setting system, a price setting method, a program, and the like capable of setting an appropriate price even when there is an exceptional demand due to circumstances on the customer side in the past data that is a basis for service price setting.

### Solution to Problem

A price setting system according to a first aspect of the present disclosure includes an input unit, a determination unit, and a price setting unit. The input unit receives demand data indicating a demand of a service in time series, the demand data being generated based on data indicating at least one action of reservation, purchase, and payment performed by a customer for the service. The determination unit determines predetermined accompanying data for the demand data. The price setting unit sets a price for the service at a predetermined target time based on the demand data and the predetermined accompanying data.

In a price setting method according to a second aspect of the present disclosure, demand data indicating a demand of a service in time series is input, the demand data being generated based on data indicating at least one action of reservation, purchase, and payment performed by a customer for the service. In the price setting method, predetermined accompanying data is determined for the demand data, and a price for the service at a predetermined target time is set based on the demand data and the predetermined accompanying data.

A program according to a third aspect of the present disclosure is a program for causing a computer to execute price setting processing. In the price setting processing, demand data indicating a demand of a service in time series is input, the demand data being generated based on data indicating at least one action of reservation, purchase, and payment performed by a customer for the service. In the price setting processing, predetermined accompanying data is determined for the demand data, and a price for the service at a predetermined target time is set based on the demand data and the predetermined accompanying data.

### Advantageous Effects of Invention

According to the present disclosure, it is possible to provide a price setting system, a price setting method, a program, and the like capable of setting an appropriate price even when there is an exceptional demand due to circumstances on the customer side in the past data that is a basis for service price setting.

### BRIEF DESCRIPTION OF DRAWINGS

FIG. 1 is a block diagram illustrating a configuration example of a price setting system according to a first example embodiment.

FIG. 2 is a flowchart for explaining an example of processing in the price setting system according to the first example embodiment.

FIG. 3 is a block diagram illustrating a configuration example of a price setting system according to a second example embodiment.

FIG. 4 is a diagram for explaining an example of demand data used in the price setting system illustrated in FIG. 3.

FIG. 5 is a diagram for explaining an example of predetermined accompanying data set in the price setting system illustrated in FIG. 3.

FIG. 6 is a diagram for explaining another example of predetermined accompanying data set in the price setting system illustrated in FIG. 3.

FIG. 7 is a diagram illustrating an example of a booking curve.

FIG. 8 is a diagram illustrating an example of information presented to an accommodation service provider side in the price setting system illustrated in FIG. 3.

FIG. 9 is a diagram illustrating another example of information presented to an accommodation service provider side in the price setting system illustrated in FIG. 3.

FIG. 10 is a flowchart for explaining an example of processing in the price setting system illustrated in FIG. 3.

FIG. 11 is a block diagram illustrating a configuration example of a price setting system according to a third example embodiment.

FIG. 12 is a flowchart for explaining an example of processing in the price setting system illustrated in FIG. 11.

FIG. 13 is a diagram illustrating an example of a hardware configuration of an apparatus.

### EXAMPLE EMBODIMENT

Hereinafter, example embodiments will be described with reference to the drawings. In addition, in the example embodiments, the same or equivalent elements are denoted by the same reference numerals, and repeated description thereof may be omitted.

### First Example Embodiment

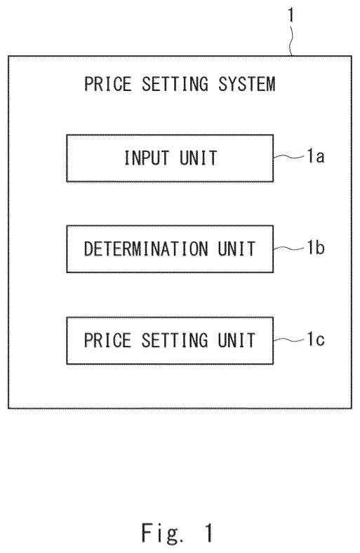

FIG. 1 is a block diagram illustrating a configuration example of a price setting system according to a first example embodiment.

As illustrated in FIG. 1, a price setting system 1 according to the present example embodiment can include an input unit 1a, a determination unit 1b, and a price setting unit 1c.

The input unit 1a receives demand data. The input unit 1a can receive demand data, for example, by reading demand data from a storage device provided in the price setting system 1 or receiving demand data from a server apparatus connected to the price setting system 1.

The demand data input herein is time-series data indicating the demand of the service, and is data generated based on data indicating at least one action of reservation, purchase, and payment performed by the customer for the service. Hereinafter, the data indicating at least one of the above actions is referred to as action data. In addition, the time-series demand data can be data in which time information is attached to or associated with each demand (that is, each action), and can be said to be data indicating the demand along the time data.

In addition, the customer to be the target of the demand data refers to a customer who uses the target service, and the demand data includes data for a plurality of customers. In addition, in the demand data, there is no need to treat customers differently.

In addition, various services such as accommodation services in hotels and inns, boarding services (use services) for airplanes, trains, and the like, services for participation in events such as sports and music, and services for use of facilities such as theme parks can be applied as the above services. Among these, the accommodation services, the services for participation in events, and the services for use of facilities are examples of the services to provide facilities or equipment to customers. The accommodation service refers to a service to provide a section (guest room) of a facility called a hotel. In hotels, inns, and the like, a lending service such as a party hall rental may be provided, but such a lending service can also be the service of the present example embodiment. Hereinafter, in the present example embodiment and a second example embodiment to be described later, an example in which the target service is an accommodation service in a hotel will be described, but other services can be similarly applied.

In addition, in the following description, reservation will be described as an example of the action, and in order to simplify the description, it will be described that the demand data does not include the data of the reservation finally canceled by cancellation or the like. This example also applies to a case where the data of the canceled reservation is removed from the demand data or a case where the canceled reservation is included separately from the reservation for which the stay is made. The latter example is one of examples in which a combination of reservation and purchase or payment is applied as an action. In addition, the action may be at least one of reservation, purchase, and payment, such as purchase or payment.

That is, the action data can be data indicating at least one of reservation, purchase, and payment for the target service. The action data may be any data as long as time-series data indicating the demand of the service can be generated. The action data when the action is reservation can be reservation data including, for example, a reservation execution date, a service provision date, the number of persons who provide the service, a service provision price, and the like. The action data when the action is purchase can be purchase data including, for example, a purchase execution date, a service provision date, the number of persons who provide the service, a service provision price, and the like. The action data when the action is payment can be payment data including, for example, a payment execution date, a service provision date, the number of persons who provide the service, a service provision price, and the like.

In the case of a hotel accommodation service, the demand data input to the input unit 1a is data indicating the demand for the accommodation service for which the price is set by the price setting unit 1c. For example, if the price to be set is a base price of a hotel, the demand data to be input includes reservation data for accommodation services of all plans set in the hotel. The all plans refer to all plans offered by hotels based on, for example, guest room rank, presence or absence of meals, smoking room/non-smoking room, and the like. The price of a certain plan can be an amount calculated as a function of the base price, such as addition/subtraction of a difference amount according to the plan to the base price or multiplication of a coefficient.

As another example, for example, if the price to be set is the price of an accommodation service of one or more plans of a hotel, the demand data to be input includes reservation data for the accommodation service of the one or more plans. However, also in this case, reservation data for accommodation services of one or more other plans can be included in the demand data to be input.

The determination unit 1b determines predetermined accompanying data for the demand data. The predetermined accompanying data can be determined as data indicating an exceptional demand (special demand) due to circumstances on the customer side, for example, can be determined as data that the accommodation service provider desires to exclude as an exception. The predetermined accompanying data can include, for example, information about at least one of the attributes of a customer (user), the number of people, and motivation, and these examples will be described in a second example embodiment.

The determination unit 1b can determine predetermined accompanying data by newly adding predetermined accompanying data as a flag or the like to the demand data. Alternatively, the determination unit 1b can determine predetermined accompanying data by designating or selecting one or a plurality of items in the demand data as the predetermined accompanying data and adding a flag or the like. The addition or the designation or selection can be automatically performed based on conditions set in advance, but can also be performed by manual operation by a service provider such as an administrator of the price setting system 1.

The price setting unit 1c sets the price of the accommodation service for the predetermined target time based on the demand data and the predetermined accompanying data (that is, based on the demand data in which the predetermined accompanying data is determined). The predetermined target time can refer to an accommodation target date in the case of an accommodation service. In addition, the predetermined target time in the case of another service varies depending on the temporal unit of use of the service, and can refer to a service use time such as any of the target date, the target date and time, the target day of the week, and the target time.

In addition, the price set by the price setting unit 1c can be a price calculated by estimation or the like at the setting time point (current time point) based on the demand data and the predetermined accompanying data. Basically, any known calculation method may be used as the calculation method, and a machine learning model can be used. However, the calculation method is different from the known calculation method in that calculation is performed in consideration of not only demand data as past data but also accompanying data.

For example, the price setting unit 1c can use data extracted from the demand data according to the accompanying data as data to be a calculation source of the price, that is, can be set based on the supply and demand balance based on the extracted data. In addition, since the supply and demand balance dynamically changes depending on the date and time, the set price also dynamically changes. Such dynamic price setting is also referred to as dynamic pricing. The price setting unit 1c can adopt various known methods for dynamic pricing, but is different from the known method in that the original data is data in which accompanying data is added as described above.

The price setting system 1 can include a control unit (not illustrated), and the control unit can include, for example, the determination unit 1b and the price setting unit c described above, or can include the input unit 1a, the determination unit 1b, and the price setting unit 1c.

This control unit can be implemented to include, for example, an integrated circuit (IC). For example, the control unit can be implemented by a central processing unit (CPU), a working memory, a non-volatile storage device storing a program, and the like. This program can be a program for causing the CPU to execute processing of the determination unit 1b and the price setting unit 1c (and processing of the input unit 1a). In addition, the storage device provided in the control unit can also be used as a storage device that stores various items used for determining accompanying data and setting a price.

In addition, the price setting system 1 can be configured as a single price setting apparatus, or can be configured as a plurality of apparatuses with functions distributed. In the latter case, each apparatus may include a control unit, a communication unit, a storage unit as necessary, and the like, and the plurality of apparatuses may be connected as necessary by wireless or wired communication to cooperate to realize the function as the price setting system 1.

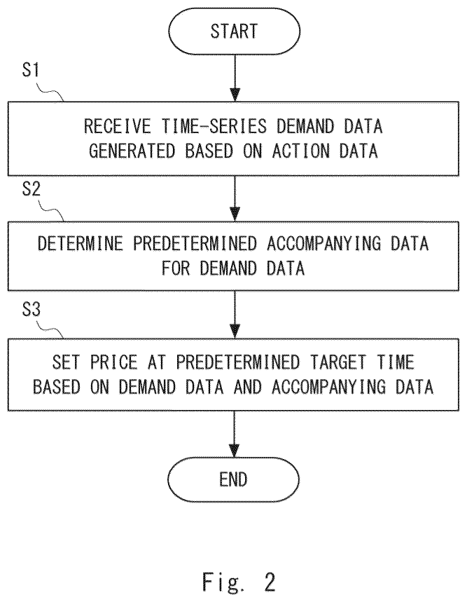

Next, a processing example of the price setting system I will be described with reference to FIG. 2. FIG. 2 is a flowchart for explaining an example of processing in the price setting system 1.

First, the price setting system I receives demand data that is generated based on action data, which is data indicating at least one action among reservation, purchase, and payment performed by a customer for a service, and indicates demand for the service in time series (step S1).

Then, the price setting system 1 determines predetermined accompanying data for the demand data (step S2), sets a price for the service at a predetermined target time based on the demand data and the predetermined accompanying data (step S3), and ends the processing.

According to the present example embodiment, even when there is an exceptional demand due to circumstances on the customer side in the past data that is a basis for price setting for services such as accommodation services, it is possible to set the price based on the predetermined accompanying data. As a result, it is possible to set an appropriate price. In other words, according to the present example embodiment, it is possible to eliminate a possibility that appropriate price setting cannot be performed in a case where there is an exceptional demand due to circumstances on the customer side in the past data.

Examples of the exceptional demand include exceptional demand such as unexpected large group reservation due to circumstances on the customer side, which is not related to general demand based on the season, the day of the week, and the like, in the reservation of a hotel or an inn. Then, if such an exceptional demand is treated without recognizing that the demand is an exception and price calculation is performed, for example, a price is set based on erroneous recognition that “demand will be higher on this day of January to December”, and there is a possibility that appropriate price setting cannot be performed. Such price calculation is similar in a case where a machine learning model is used. That is, causing the machine learning model to learn without recognizing such an exceptional demand in one day as “this demand is only an exception” means that erroneous learning such as “demand will be higher on this day of January to December” is performed. Therefore, even in the price setting using the learning model, if the learning is performed based on the erroneous recognition, there is a possibility that the price cannot be set to an appropriate price. On the other hand, according to the present example embodiment, since the price can be set by reflecting such an exceptional demand as the predetermined accompanying data, it is possible to set the price in consideration of the exceptional demand.

### Second Example Embodiment

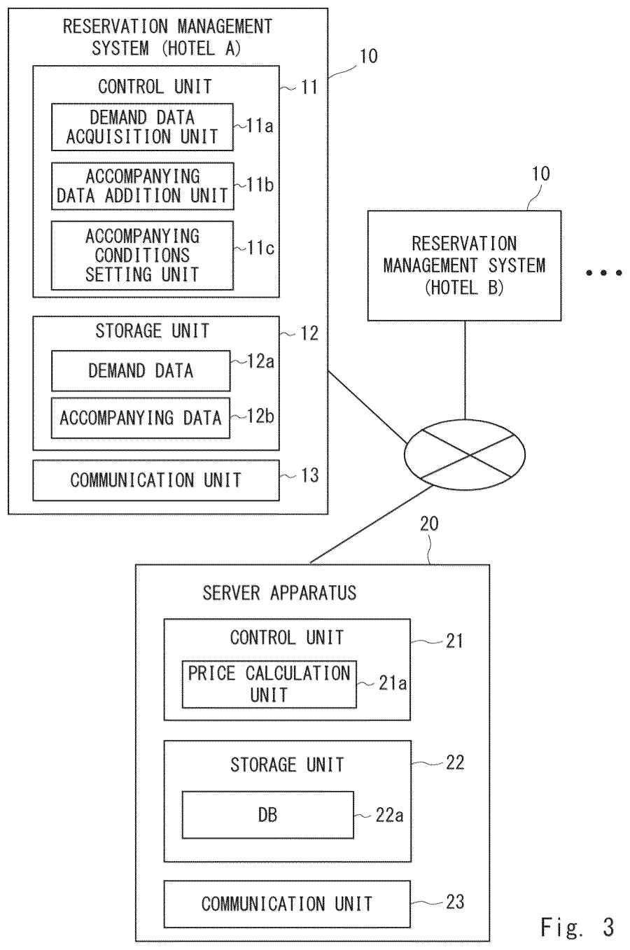

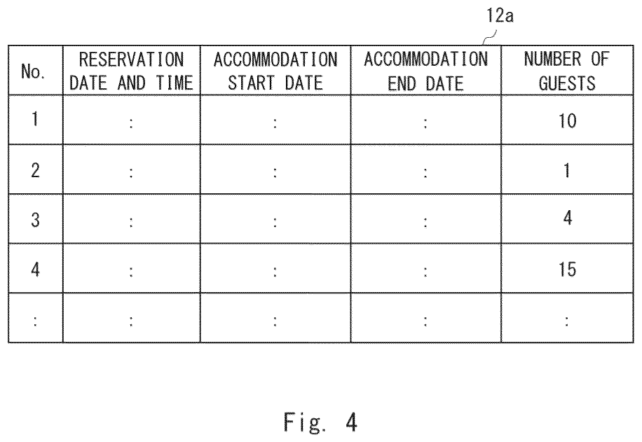

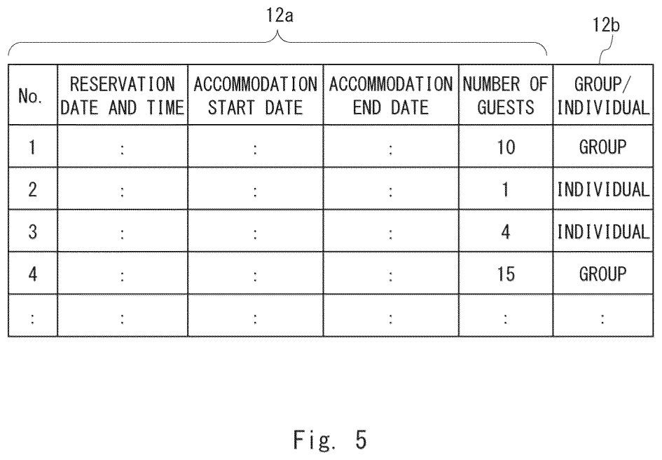

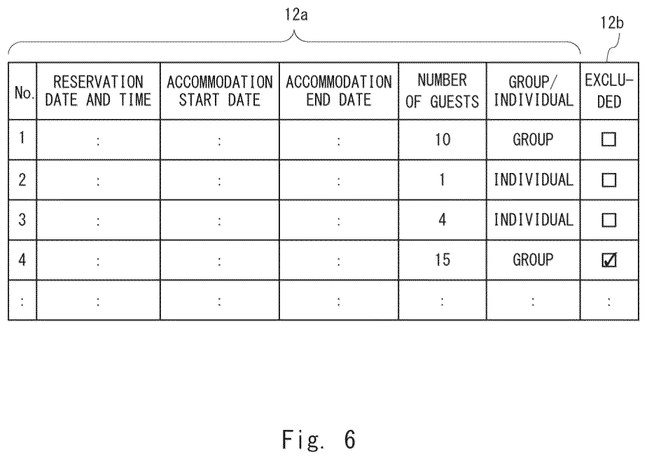

A second example embodiment will be described focusing on differences from the first example embodiment with reference to FIGS. 3 to 10, but various examples described in the first example embodiment can be applied. FIG. 3 is a block diagram illustrating a configuration example of a price setting system according to the second example embodiment. FIG. 4 is a diagram for explaining an example of demand data used in the price setting system of FIG. 3, and FIG. 5 is a diagram for explaining an example of predetermined accompanying data set in the price setting system of FIG. 3. In addition, FIG. 6 is a diagram for explaining another example of predetermined accompanying data set in the price setting system illustrated in FIG. 3.

In the present example embodiment, an accommodation service of a hotel is taken as an example of the target service, but other types of services can be similarly applied by making a change suitable for the service (for example, a change in definition of action). In addition, also in the present example embodiment, reservation will be described as an example of the action, and in order to simplify the description, it will be described that the demand data does not include the data of the reservation finally canceled by cancellation or the like.

The price setting system (hereinafter, this system) illustrated in FIG. 3 is configured by connecting a reservation management system 10 provided for each hotel and a server apparatus 20 for calculating a price through a network. In addition, the reservation management system 10 can include, for example, a server apparatus that can be browsed, operated, and the like from an installed or portable terminal apparatus in a hotel. The reservation management system 10 is not limited to a single apparatus, and may be configured by apparatuses that are distributed. In addition, by providing the function of the server apparatus 20 in each reservation management system 10, for example, this system can be constructed in each hotel.

The reservation management system 10 can include a control unit 11, a storage unit 12, and a communication unit 13. The control unit 11 is a unit that controls the entire reservation management system 10, and can include a demand data acquisition unit 11a, an accompanying data addition unit 11b, and an accompanying conditions setting unit 11c to be described later. In addition, the reservation management system 10 may not include the accompanying conditions setting unit 11c.

The control unit 11 can be implemented to include, for example, an IC. For example, the control unit 11 can be implemented by a CPU, a work memory, a non-volatile storage device storing a program, and the like. This program can be a program for causing the CPU to execute processing of each of the units 11a and 11b or processing of each of the units 11a to 11c. In addition, this program can include a program for causing the CPU to execute processing for general reservation management other than these processing although detailed description thereof is omitted. In addition, the storage device included in the control unit 11 can also be used as the storage unit 12. The storage unit 12 includes a storage device, and the communication unit 13 can include a communication interface for communicating with the server apparatus 20 through a network.

The server apparatus 20 is an apparatus that receives data serving as a calculation source from the reservation management system 10, calculates a price of an accommodation service, and returns the calculated price to reservation management system 10. Hereinafter, an example in which the server apparatus 20 calculates the price of the accommodation service for the reservation management system 10 of the hotel A will be described, but the server apparatus 20 can individually provide such price calculation processing for each reservation management system 10. However, for example, if a plurality of nearby hotels including the hotel A are managed by one reservation management system 10 and the accommodation services of the plurality of hotels are the same, a common price can be calculated. The server apparatus 20 is not limited to a single apparatus, and may be configured by apparatuses that are distributed.

The server apparatus 20 can include a control unit 21, a storage unit 22, and a communication unit 23. The control unit 21 is a unit that controls the entire server apparatus 20, and can include a price calculation unit 21a to be described later.

The control unit 21 can be implemented to include, for example, an IC. For example, the control unit 21 can be implemented by a CPU, a work memory, a non-volatile storage device storing a program, and the like. This program can be a program for causing the CPU to execute the processing of the price calculation unit 21a. In addition, the storage device included in the control unit 21 can also be used as the storage unit 22. The storage unit 22 includes a storage device, and the communication unit 23 can include a communication interface for communicating with each reservation management system 10 through a network.

Details of the reservation management system 10 will be described.

The demand data acquisition unit 11a is an example of the input unit 1a in FIG. 1, and acquires demand data 12a stored (accumulated) in the storage unit 12. The demand data 12a to be acquired can exclude data before a predetermined period. For example, the demand data 12a to be acquired can be only the demand data 12a of the past two years. In addition, the demand data acquisition unit 11a can also acquire demand data stored in an external server apparatus (not illustrated) through the communication unit 13, for example. The demand data 12a can be generated by registering from the terminal apparatus described above as reservation data indicating reservation of the accommodation service, registering from a reservation site provided by the hotel A or the like, or registering from both of them. However, the demand data 12a may be edited from the above-described terminal apparatus or the like after such registration. As described above, the demand data 12a can also be generated by performing any processing based on the reservation data.

The target customer of the demand data 12a refers to a customer who uses the target accommodation service, and the demand data 12a includes data on a plurality of customers. In addition, for simplification of description, it is assumed herein that the demand data 12a is demand data for an accommodation service corresponding to one accommodation plan of the hotel A, but the demand data is not limited thereto as described in the first example embodiment.

As exemplified in FIG. 4, the demand data 12a can include, as items of information, information for identifying a reservation (number, id, reservation name indicating reservation person or group, and the like), a reservation date (date on which the reservation is made), an accommodation date, and the number of guests in association with each other. In the example of FIG. 4, an example in which an accommodation start date (check-in date) and an accommodation end date (check-out date) are included as accommodation dates is described. As exemplified in FIG. 4, the demand data 12a is time-series data in which the accommodation date can be specified.

As described later, the price is calculated based on data obtained from the demand data 12a exemplified in FIG. 4. Then, a period (lead time) from the reservation date and time to the accommodation start date (that is, the accommodation target date) affects the calculation of the price, for example, the effect that the reservation cannot be made unless the price is lowered as it is closer to the accommodation target date. Therefore, the demand data 12a includes information indicating the lead time.

The accompanying data addition unit 11b is an example of the determination unit 1b in FIG. 1, and adds predetermined accompanying data to the demand data 12a. For example, it can be understood that the group customer is an exceptional demand (special demand) due to circumstances on the customer side. When this way of understanding is adopted, the accompanying data addition unit 11b newly adds data indicating whether or not the customer is a group customer (whether the customer is an individual customer) as predetermined accompanying data to each record of the demand data 12a of FIG. 4, as accompanying data 12b exemplified in FIG. 5. The accompanying data 12b in FIG. 5 can be added to each record as, for example, either a flag indicating a group customer or a flag indicating an individual customer.

This addition can be performed by automatically selecting a group/individual based on, for example, predetermined conditions. Examples of the conditions include a condition that a group customer is determined when the number of guests indicated by the demand data 12a is 11 or more and an individual customer is determined when the number of guests indicated by the demand data is less than 11. As another example, it is also possible to use a condition that a customer name (a name of a person or a group who has made a reservation) is included in the demand data 12a, and a record extracted as a name indicating the group name by analyzing the customer name is a group customer and other records are individual customers. Alternatively, this addition can be performed by manual operation by the accommodation service provider. The accompanying data 12b can be stored in the storage unit 12 so as to be associated with the demand data 12a in this manner.

In FIG. 5, the accompanying data 12b indicating either the group customer or the individual customer is exemplified as the predetermined accompanying data, but the predetermined accompanying data may be data indicating that information not used for price calculation described later is excluded. Specifically, as exemplified by the accompanying data 12b for the demand data 12a in FIG. 6, the accompanying data addition unit 11b can present the demand data 12a to the terminal apparatus with a check box added so that the accommodation service provider can select an exclusion target. Then, in response to the operation by the accommodation service provider to select the exclusion target, the accompanying data addition unit 11b can generate predetermined accompanying data that can be expressed by the accompanying data 12b of FIG. 6 based on the operation. The accompanying data 12b in FIG. 6 is an example in which a record of No. 4 is selected as an exclusion target. In this case, a flag indicating that the checked record of No. 4 is excluded is added as predetermined accompanying data.

In addition, for example, the accompanying data addition unit 11b can automatically designate or select one or a plurality of items (for example, items of group/individual) in the demand data such as the demand data 12a illustrated in FIG. 6 and automatically add a flag or the like corresponding to the value of the item as predetermined accompanying data. The flag corresponding to this item can be added, for example, according to a standard in which, among the information indicating the group customer in the group/individual item, 10 people are not excluded as an exceptional demand, but 11 people or more are excluded.

In addition, FIG. 6 illustrates an example in which the information in which the exclusion target is selected in the check box is added as the accompanying data 12b, but the present invention is not limited thereto. For example, the accompanying data addition unit 11b can present a GUI image for selecting and inputting conditions to be excluded, such as excluding a customer reserved by 11 people or more, from options stored in advance, and can receive an input of the conditions to be excluded from the terminal apparatus. Here, as the above options, conditions for items included in the demand data 12a can be indicated. As a result, the accompanying data addition unit 11b can add information satisfying the conditions, among the demand data 12a, as the accompanying data 12b indicating the exclusion target. In addition, instead of this GUI image, a GUI image for inputting conditions to be excluded by text, a formula, or the like can be presented.

In the various examples described above, an example has been described in which the predetermined accompanying data includes information indicating whether the customer is a group customer or an individual customer as the information of the attribute of the customer. However, the predetermined accompanying data can include information of other attributes such as whether the customer is a foreign customer or a Japanese customer. It is beneficial for hotels in areas where foreign guests can be regarded as an exceptional demand. In addition, when the demand data does not include the number of customers as in the demand data 12a of FIG. 4, the predetermined accompanying data can also include information about the number of customers. The information about the number of customers may be information indicating the number of customers themselves, or may be, for example, information indicating whether the number of customers is less than 11 or 11 or more. In any case, the calculation of the price may be performed excluding data of, for example, 11 people or more at the time of calculating the price. In addition, the predetermined accompanying data can include information about the motivation of the customer. The information about the motivation of the customer includes, for example, information indicating that the stay is for an event that is not held every year and is held suddenly. In addition, combinations of the various examples described above can be used as predetermined accompanying data. That is, the predetermined accompanying data can include at least one piece of information of the number of customers and the motivation.

In addition, an example has been described in which the predetermined accompanying data includes information indicating whether the customer is a group customer or an individual customer as the information of the attribute of the customer, but further classification is also possible. For example, the predetermined accompanying data can include information indicating whether the customer is (1) a customer of a group that has made a reservation suddenly, (2) a customer of a group that has made a reservation non-suddenly, or (3) an individual customer. Among the above (1) to (3), a record in which the predetermined accompanying data indicates the above (1) can be regarded as an exceptional demand.

Here, the difference in definition between the above (1) and the above (2) can be determined based on, for example, whether the reservation date and time has been made within a predetermined period prior to the accommodation date or before the predetermined period. However, the present invention is not limited to this example, and a group reservation that is not treated as an exception even for a group reservation (reservation of a large customer) can be designated by the accommodation service provider or automatically selected. As another method of automatic selection in this case, for example, a group name is extracted, and a group name having been reserved before the reservation can be selected so as not to be treated as an exception. The reason why such a determination is not made in the above (3) is that it can be statistically said that such an individual customer can occur similarly even if the individual customer makes a reservation suddenly, and it is not necessary to consider such an individual customer as an exception.

Next, the accompanying conditions setting unit 11c will be described. The accompanying conditions setting unit 11c is a setting unit that sets conditions for information to be included in predetermined accompanying data. The conditions are hereinafter referred to as accompanying conditions. The accompanying conditions refers to the predetermined conditions described above, for example, the accompanying conditions can refer to a condition that a group customer is determined when the number of guests indicated by the demand data 12a is 11 or more and an individual customer is determined when the number of guests indicated by the demand data is less than 11. The accompanying conditions setting unit 11c can include an operation unit through which the accommodation service provider performs a setting operation from the terminal apparatus or the like, and can receive the setting operation and set the accompanying conditions. According to this setting, the accompanying data addition unit 11b can add accompanying data. For example, when the accompanying conditions setting unit 11c sets, as accompanying conditions, a condition as to whether the number of guests is 11 or more, the accompanying data addition unit 11b can add information indicating whether the customer is a group customer or an individual customer as predetermined accompanying data.

Then, the control unit 11 transmits the demand data 12a, to which the predetermined accompanying data 12b is added by the accompanying data addition unit 11b, to the server apparatus 20 through the communication unit 13 as the price calculation source data. Alternatively, the control unit 11 removes data indicating an exceptional demand from the demand data 12a based on the demand data 12a to which the predetermined accompanying data 12b is added by the accompanying data addition unit 11b. Then, the control unit 11 transmits the demand data after the removal to the server apparatus 20 through the communication unit 13 as the price calculation source data. In any case, it is necessary that data necessary at least until the time point when the price is set is transmitted to the server apparatus 20. For example, the data transmission can be sequentially performed every time the transmission data is collected, or can be performed every certain period.

Details of the server apparatus 20 will be described.

The communication unit 23 receives the price calculation source data transmitted from the reservation management system 10 of the hotel A, and transmits the data to the control unit 21. The price calculation unit 21a of the control unit 21 is an example of a unit having at least some functions of the price setting unit 1c in FIG. 1. Based on the price calculation source data, that is, based on the demand data and the predetermined accompanying data, the price calculation unit 21a calculates a price of the accommodation service for a predetermined target time (accommodation target date).

In an example in which the demand data 12a to which the predetermined accompanying data 12b is added is received from the reservation management system 10 as price calculation source data, the price calculation unit 21a, first, removes data indicating an exceptional demand from the demand data 12a based on the predetermined accompanying data 12b. Then, the price calculation unit 21a calculates the price of the target accommodation service on the predetermined accommodation target date based on the demand data after the removal. In an example in which the demand data after removal, which is the demand data 12a reflecting the predetermined accompanying data 12b, is received from the reservation management system 10 as the price calculation source data, the following calculation is performed. That is, the price calculation unit 21a calculates the price of the target accommodation service on the predetermined accommodation target date based on the received demand data after removal.

Here, an example in which the data indicating the exceptional demand is removed, in other words, an example in which the weighting of the data indicating the exceptional demand is set to zero has been described. However, the data indicating the exceptional demand may only be weighted smaller than the data indicating the non-exceptional demand. Instead of completely removing the data indicating the exceptional demand, the influence of the data indicating the exceptional demand on the calculated price can be reduced only by reducing the weight compared to other data.

As described above, the price calculation unit 21a can perform weighting processing on the demand data 12a based on the predetermined accompanying data 12b and calculate the price based on the demand data after the weighting processing. In addition, the accompanying conditions setting unit 11c can also set the weighting factor of the weighting processing as a part of the conditions for the information included in the predetermined accompanying data, that is, as a part of the accompanying conditions. In this case, the set weighting factor is transmitted to the server apparatus 20 and used by the price calculation unit 21a to calculate a price subjected to the weighting processing.

In addition, the predetermined accommodation target date can be designated from the reservation management system 10 side, or can be automatically designated as several days after the current point according to the received data, and needless to say, a plurality of dates can be designated.

For example, the price calculation unit 21a can calculate the price based on the supply and demand balance for the accommodation target date by adopting various known methods for dynamic pricing. However, as described above, this method is different from the known method in that the original data is data in which accompanying data is added.

For example, the price calculation unit 21a can perform the calculation with reference to a calculation database (DB) 22a stored in the storage unit 22. The DB 22a can be a database corresponding to a learning model obtained by machine learning from, for example, past price calculation source data, a calculation result based on the data, and information indicating total sales at the hotel A when the price of the calculation result is used. Not limited to this example, the price calculation unit 21a can input the calculation source data to the learning model, and predict (estimate) an optimal price of a predetermined accommodation target date of the target accommodation service based on the supply and demand balance.

It does not matter whether the algorithm of the learning model used herein is used or whether there is teacher data, but it can be said that an optimal price can be predicted by using teacher data to which a correct answer flag is attached based on information indicating total sales or the like as the learning data.

As to what information is included in the learning data, in other words, what information is input together with the price calculation source data at the time of calculating the price (at the time of management), a known method may be adopted, and some examples will be given, but the details thereof will be omitted.

For example, the learning data and the input data at the time of operation can be more accurately predicted by including some or all of the following information in association with the price calculation source data. Examples of the information to be included include information related to dates such as seasons, days of the week, and holidays, information about events held in the vicinity of the hotel A, information about nearby hotels and inns that compete with each other, and information indicating various external factors such as social situations. An event may be distinguished from an event periodically performed, such as an annual event, and an initial event. In addition, examples of the social situation include the presence or absence of a declaration of an emergency caused by, for example, the spread of an infectious disease. For example, even when the declaration is canceled after the declaration of an emergency situation is made, the presence or absence of the declaration of an emergency situation is included as one of the parameters of the prediction, so that it is possible to reduce the influence of the declaration of an emergency situation and calculate an appropriate price.

In addition, when the target service is a service for providing a facility or equipment to a customer as in the accommodation service exemplified herein, predetermined accompanying data can be determined as follows. That is, the predetermined accompanying data can also include information indicating a facility or equipment that cannot be provided at a predetermined target time (an accommodation target date in the accommodation service) among the facilities or equipment to be provided.

For example, the learning data and the input data at the time of operation can include information indicating the number of remaining rooms that can be provided and the number of people that can be reserved, or can include information indicating a period from a date at the time of calculation to a predetermined accommodation target date. As for the number of remaining rooms that can be provided, rooms that cannot be provided due to refurbishment work or special cleaning on the accommodation target date are not counted. In addition, for example, if the above period is short, there is a possibility that reservation cannot be made unless the price is lowered. Therefore, it can be said that it is beneficial to include such information in the learning data and the input data at the time of operation. In addition, instead of the number of remaining rooms or together with the number of remaining rooms, the number of reserved rooms can be included in the learning data and the input data at the time of operation.

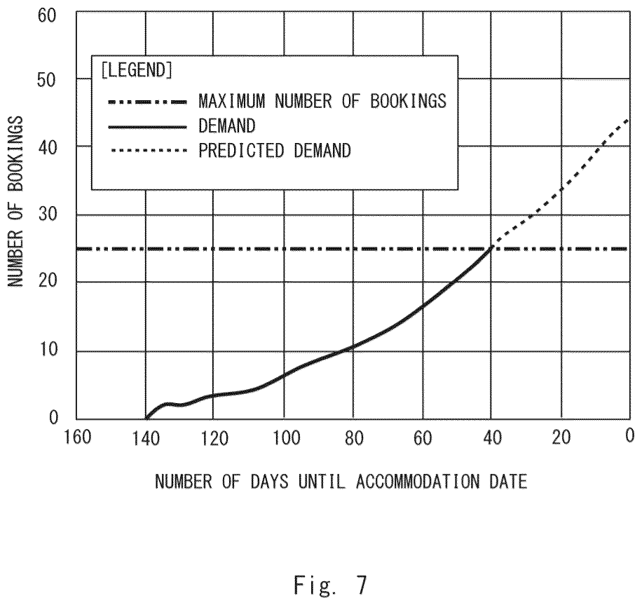

In addition, the learning model used in the price calculation unit 21a can also be generated by adopting the method described in Patent Literature 1, for example. That is, the learning model can also perform machine learning and update based on a result of comparison between a time-series change in the number of guest room reservations on the first date in a period until the first date in the future (the predetermined accommodation target date) and an ideal booking curve extracted from the past data. For example, as exemplified in FIG. 7, the booking curve can be a curve indicating the relationship between the number of days until the accommodation date and the number of bookings (the number of reservations).

However, in this case, in the present example embodiment, since the booking curve to be extracted is extracted from the data from which the exceptional demand is partially or completely removed, the generated learning model is also a model from which the influence of such an exceptional demand is partially or completely removed. That is, in the present example embodiment, it is possible to generate a learning model having no or low influence on the exceptional demand by completely removing the exceptional demand that disturbs the accuracy of the extracted booking curve or performing weighting so as to lower the influence. As a result, in the present example embodiment, it is possible to calculate a price with no or low influence on exceptional demand even at the time of operation.

In addition, the present invention is not limited to this example even when the booking curve is used. For example, in the learning stage, a demand prediction model is generated as a learning model by using past demand data, and a booking curve for a target plan or a room is extracted or classified. The demand prediction model in this example can be generated using, for example, the demand data 12a for the past two years for the target plan or room as learning data. Here, as an influence factor, seasonal characteristics (month, day of week), availability of a target plan or room (inventory information), and surrounding event information are also included in a part of the learning data, and information indicating a group customer or an individual customer is also included in a part of the learning data. The demand prediction model generated in this manner can reflect the degree of influence on demand for each factor including whether the customer is a group customer or an individual customer, in other words, can measure the degree of influence. Then, for the target plan or room from the reservation date (sales date) to the accommodation target date, it is determined whether to extract the corresponding booking curve or to classify the target plan or room into a plurality of booking curves by using the past demand data to which predetermined accompanying data is added.

Then, in the operation stage, reservation data (on-hand data) at the current date and time is input to a demand prediction model obtained by combining the generated demand prediction model and the determined booking curve, and the demand prediction model is learned and updated. As a result, the demand prediction model in which the on-hand data is also reflected in the demand prediction is generated, and the latest demand can be predicted from the divergence between the booking curve and the real-time information that cannot be captured by the demand prediction model not using the on-hand data. The real-time information herein can refer to event information, a price of a competing hotel, and the like. Thereafter, an appropriate price (recommended price) for maximizing the profit as the hotel A can be calculated based on the prediction result. The recommended price can be calculated, for example, by selecting an optimal price combination for realizing profit maximization from all patterns for each plan or room and for each price, and the price indicated by such an optimal price combination can be obtained for each plan or room.

Another example using a booking curve will be described. For example, statistical processing such as calculating a plurality of types of booking curves from the demand data 12a while changing a record to be removed and calculating a variance of each booking curve is performed. The variance of the booking curve can be defined as, for example, the sum of the squares of the differences in the number of books for the number of days until each accommodation date from the booking curve obtained from all of the demand data 12a. Then, as the predetermined accompanying data, it is possible to determine a booking curve corresponding to a statistical error (for example, a booking curve having a variance equal to or greater than a predetermined value). In this case, for example, a distribution threshold value may be transmitted from the reservation management system 10 to the server apparatus 20.

Then, for example, statistical processing such as calculation of an average value or a median value of the number of books for the number of days until each accommodation date is performed on the group of booking curves excluding the determined booking curve, so that the booking curve used for comparison can be generated. Alternatively, for example, statistical processing such as calculation of an average value or a median value of the number of books for the number of days until each accommodation date is performed on the record used in the group of booking curves excluding the determined booking curve, so that the booking curve used for comparison can be generated.

In addition to the example of using the booking curve, such a statistical processing method can also be adopted. For example, first, the accompanying data addition unit 11b performs statistical processing on the number of people for each customer from the demand data 12a to calculate the number of people corresponding to a statistical error (for example, the number of people whose variance is equal to or greater than a predetermined value).

Then, the accompanying data addition unit 11b determines a record in which the number of people is described as predetermined accompanying data, and adds a flag indicating an exceptional demand to the record. Then, the price calculation unit 21a of the server apparatus 20 calculates the price by using the record excluding the record in which the determined number of people is described (the record to which the flag indicating the exceptional demand is added) or by lowering the weighting factor of the added record than other records.

Alternatively, the accompanying data addition unit 11b may transmit to the server apparatus 20 the data subjected to the weighting processing without adding the flag, and the price calculation unit 21a may calculate the price using the data as the price calculation source data.

In addition, although the description has been given on the assumption that the price calculation unit 21a calculates the price using the learning model, the present invention is not limited thereto. The price calculation unit 21a can also obtain a calculation result by inputting a variable to a predetermined calculation formula using, for example, information included in the price calculation source data described above and some or all of other various pieces of information as variables.

As described above with respect to the price calculation unit 21a, it can be said that the price calculation unit 21a is an example of a unit having at least some functions of the price setting unit 1c in FIG. 1. The remaining functions can be provided by the control unit 11 of the reservation management system 10.

The control unit 21 of the server apparatus 20 can return data indicating the calculated price to the reservation management system 10 through the communication unit 23. Then, in the reservation management system 10 that has received the data through the communication unit 13, the control unit 11 sets the price to the price indicated by the data or stores the price in the storage unit 12 in a state where the price can be displayed on a display unit (not illustrated). In either case, the reservation management system 10 can display the calculated price on a display unit (not illustrated). Then, the price can be automatically adopted as an official price as it is to set the price, or the service provider side can determine the price to be officially adopted with reference to the price as necessary, and the determined price can be input and set. In either case, the price set for the target accommodation service is registered and used in order to make reservations or payments for the accommodation service using the reservation management system 10.

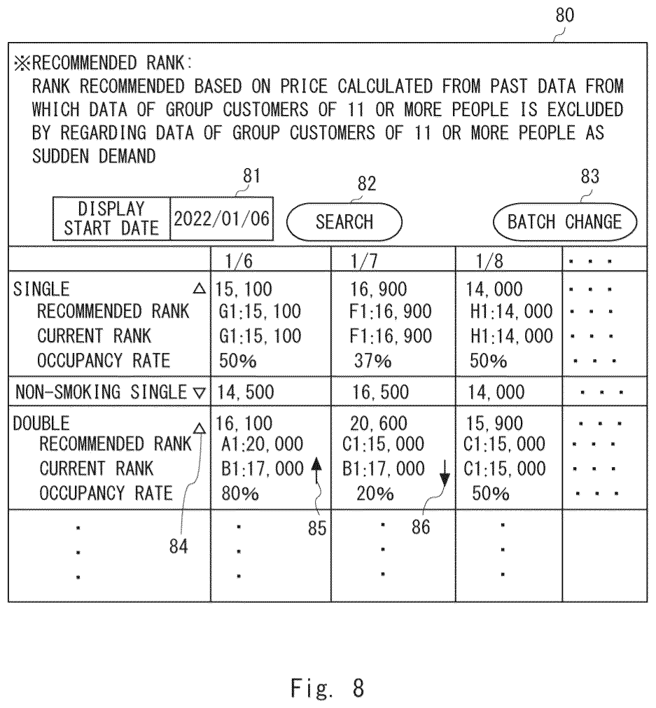

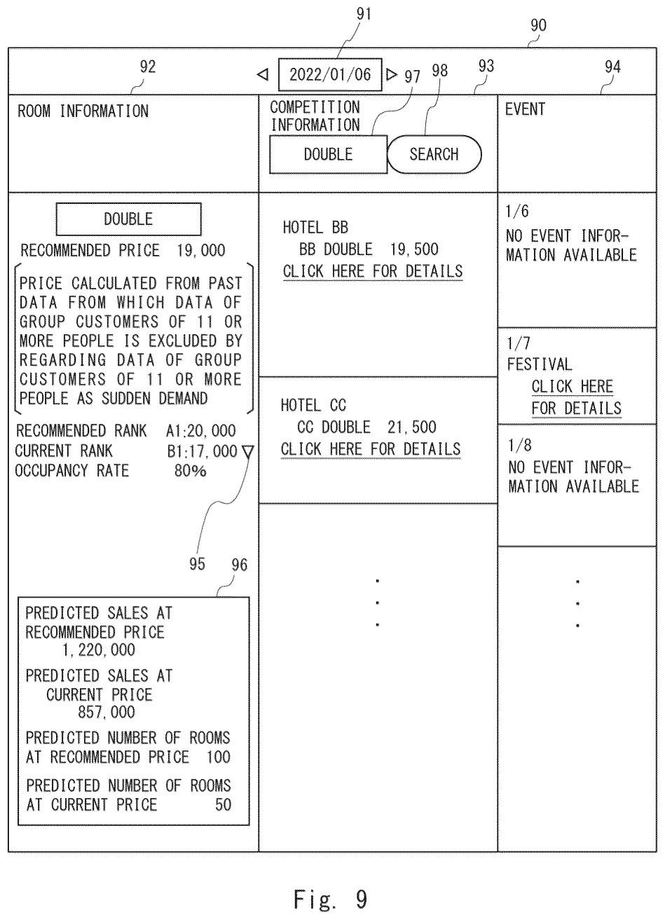

Here, an example in which the service provider side determines the price with reference to the calculated price will be described with reference to FIGS. 8 and 9. FIG. 8 is a diagram illustrating an example of information presented to the accommodation service provider side in this system. In addition, FIG. 9 is a diagram illustrating another example of information presented to the accommodation service provider side in this system.

Here, an example of presenting not only one plan of the accommodation service of the hotel A but also a result of individually calculating the price for a plurality of plans or a result of calculating the base price and performing a calculation based on the base price will be described. In the latter case, as described in the first example embodiment, the price of a certain plan can be an amount calculated as a function of the base price, such as addition/subtraction of a difference amount according to the plan to the base price or multiplication of a coefficient.

The reservation management system 10 that receives the price calculated as a reply from server apparatus 20 stores the price (calculated price) so that the price can be browsed from the terminal apparatus. In response to the access from the terminal apparatus, the reservation management system 10 can transmit a graphical user interface (GUI) image including the calculated price to the terminal apparatus and display the GUI image on the display unit of the terminal apparatus as exemplified by a GUI image 80 in FIG. 8.

The GUI image 80 can include a display start date input field 81, a search button 82, and a batch change button 83. The search button 82 is a button for displaying the recommended rank, the recommended price, and the occupancy rate for each plan (here, for each room type) in a predetermined period (for example, one week) including the date input in the input field 81. Here, the recommended price can be a price closest to the calculated price, a highest price that does not exceed the calculated price, or a lowest price that does not fall below the calculated price among a plurality of prices set for each plan in the hotel A. The recommended rank indicates, for example, a rank corresponding to a recommended price calculated from the past data from which data of group customers of 11 people or more is excluded by regarding the data of group customers of 11 people or more as sudden demand, among ranks corresponding to each of a plurality of set prices. In addition, as exemplified by the GUI image 80, information indicating the meaning of the recommended rank can be presented to an administrator, a person in charge of price setting, or the like in the hotel A. Similarly, information indicating the meaning of the recommended price can also be included in the GUI image 80. That is, the information indicating the meaning of at least one of the recommended rank and the recommended price may be presented to an administrator, a person in charge of price setting, or the like in the hotel A. With such presentation, it can be understood that the recommended rank and the recommended price are calculated from data excluding the sudden demand and the sudden demand can be determined without being considered by the hotel A. The occupancy rate refers to a ratio of fully reserved rooms among rooms corresponding to the current target plan.

The GUI image 80 includes information about plans such as single, non-smoking single, and double, and can include a display switching button 84 for switching between simplified display and detailed display, for example, for each plan. In the example of FIG. 8, details of single and double are displayed, and a simple display of non-smoking single is displayed. The information about the plan includes the amount of money in the currently set rank (current rank) of the plan in both the simple display and the detailed display, and includes the current rank and the current price and the recommended rank and the recommended price in the detailed display.

For example, a pull-down menu (not illustrated) can be displayed in the display region of the current rank for each plan and each date. As a result, an administrator, a person in charge of price setting, or the like on the accommodation service provider side can change the current rank while checking the information displayed in the GUI image 80 using the terminal apparatus, and can correct the price corresponding to the changed current rank to the current price. Needless to say, even when the current rank is changed, the rank can be changed to a rank other than the recommended rank. Alternatively, either the recommended rank or the current rank can be selectively displayed and selected.

In addition, an upward arrow 85 is displayed when the recommended price is higher than the current price, and a downward arrow 86 is displayed when the recommended price is lower than the current price. For example, the thickness or color of the upward arrow 85 and the downward arrow 86 can be changed according to the magnitude of the difference between the current price and the recommended price. It is also possible to configure such that an administrator, a person in charge of price setting, or the like on the accommodation service provider side can change and set the price of the target plan and the date from the current price to the recommended price by selecting the upward arrow 85 or the downward arrow 86 using the terminal apparatus.

The batch change button 83 is a button for collectively setting the recommended price, and when the batch change button 83 is selected, the recommended price is registered for all plans and the displayed date (accommodation target date).

In addition, in response to the access from the terminal apparatus, the reservation management system 10 can transmit a GUI image including the calculated price to the terminal apparatus and display the GUI image on the display unit of the terminal apparatus, as exemplified by the GUI image 90 in FIG. 9. In addition, in the GUI image 80, display can be switched to a GUI image 90 by selecting a button (not illustrated) or selecting a target plan name (for example, double). In addition, it is also possible to switch from the GUI image 90 to the GUI image 80.

The GUI image 90 includes an input field 91 for the display date (accommodation target date) and a movement button for moving the display date forward or backward, and room information 92, competition information 93, and event information 94 for the target plan (double in this example) on the accommodation target date input in the input field 91.

The room information 92 can include, for the date input in the input field 91, respective pieces of information of a recommended price that is the calculated price itself of the target plan, a recommended rank, a recommended price corresponding to the recommended rank, a current rank, a current price, and an occupancy rate. The recommended price which is the calculated price itself of the target plan is, for example, a price calculated from the past data from which data of group customers of 11 people or more is excluded by regarding the data of group customers of 11 people or more as sudden demand. In addition, for the recommended price included in the room information 92, as illustrated in FIG. 9, for example, information indicating that the recommended price is calculated from the past data from which data of group customers of 11 people or more is excluded by regarding the data of group customers of 11 people or more as sudden demand can be included for the purpose of explanation. In addition, as described in the GUI image 80 of FIG. 8, information indicating the meaning of the recommended rank included in the room information 92 can also be included. In addition, the room information 92 can include predicted sales and the predicted number of rooms (the predicted number of reserved rooms) at the recommended price and/or the calculated price corresponding to the recommended rank, and predicted sales and the predicted number of rooms at the current price. In addition, the room information 92 can also include information indicating the meaning of the recommended price corresponding to this recommended rank.

The competition information 93 can include an input field 97 for inputting a plan or a room type and a search button 98 for displaying information about an information providing site or a site of a competing hotel through the Internet or the like based on the information input in the input field 97. In the input field 97, a plan or a room type that will correspond to the plan displayed in the room information 92 can be manually or automatically input. When the search button 98 is selected in this state, the plan name of each of the competitive hotels corresponding to the information input in the input field 97, the price of the date, and a link to a site (for example, an information providing site or a site of each of the competitive hotels) on which the details are posted can be included.

The event information 94 includes information about a nearby event held in a predetermined period including the accommodation target date, and when there is an event, can include a link to a site including details of the event. In addition, in the fields of the competition information 93 and the event information 94, a scroll bar according to the amount of information may be displayed so that necessary information can be browsed.

In the display region of the current rank of the room information 92, for example, a button 95 for displaying a pull-down menu can be displayed. As a result, the administrator, the person in charge of price setting, or the like on the accommodation service provider side can change the current rank while checking the various kinds of information displayed in the GUI image 90 using the terminal apparatus, and can correct the price corresponding to the changed current rank to the current price. Needless to say, even when the current rank is changed, the rank can be changed to a rank other than the recommended rank. Alternatively, either the recommended rank or the current rank can be selectively displayed and selected.

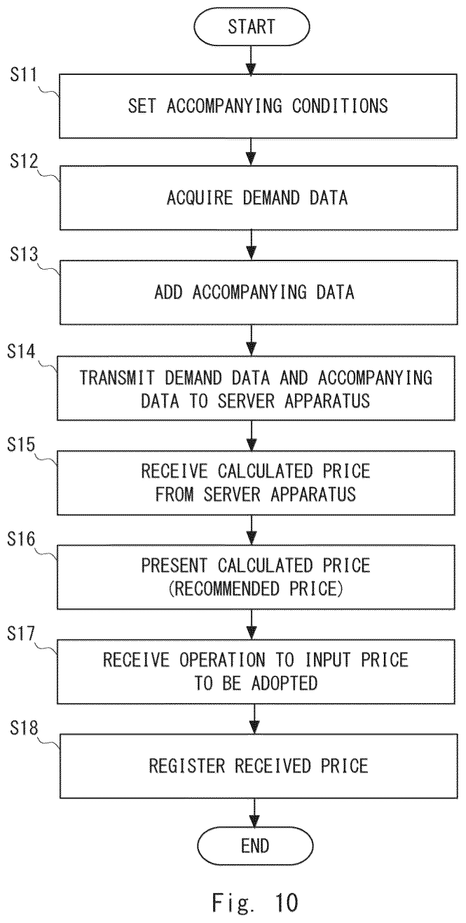

Next, a processing example of this system will be described with reference to FIG. 10. FIG. 10 is a flowchart for explaining an example of processing in this system.

First, an administrator, a person in charge of price setting, or the like on the accommodation service provider side sets accompanying conditions by using a terminal apparatus, and the accompanying conditions setting unit 11c of the reservation management system 10 registers the setting (step S11). The accompanying conditions can include, for example, information indicating whether to add predetermined accompanying data according to the distinction between the group and the individual, whether to add predetermined accompanying data according to the distinction between the foreign customer and the Japanese customer, and the like, and a weighting factor used in the weighting processing. Then, the demand data acquisition unit 11a acquires the demand data 12a from the storage unit 12 or the like (step S12), and the accompanying data addition unit 11b adds the predetermined accompanying data 12b to the demand data 12a based on the accompanying conditions (step S13). Then, the control unit 11 transmits the demand data 12a to which the predetermined demand data 12b is added to the server apparatus 20 through the communication unit 13 (step S14).

Then, the server apparatus 20 receives this data, and the price calculation unit 21a calculates the target date and the price of the plan using this data as price calculation source data and returns the calculated price to the reservation management system 10. The control unit 11 of the reservation management system 10 receives the calculated price through the communication unit 13, and stores the calculated price in the storage unit 12 (step S15). Then, in response to a request from the terminal apparatus, the control unit 11 of the reservation management system 10 presents the calculated price, the recommended price, the recommended rank, and the like to the terminal apparatus through the GUI image exemplified in FIG. 8 or 9 (step S16). Then, the control unit 11 receives an operation such as input of a price to be adopted from the terminal apparatus (step S17), stores the received price in the storage unit 12 to register the received price as a price to be formally applied (step S18), and ends the processing. In addition, the price registered herein is adopted as a price that forms a part of reservation from a customer or future demand data.

According to the present example embodiment, similarly to the effects of the first example embodiment, even when there is an exceptional demand due to circumstances on the customer side in the past data that is a basis for price setting for accommodation services, it is possible to set the price based on the predetermined accompanying data. As a result, it is possible to set an appropriate price. For example, when there are five hotels to be managed in the neighborhood and, among 500 rooms that can be provided by one of the five hotels, 20 rooms are reserved as general reservations and 400 rooms are reserved as group reservations, the price of the remaining rooms is set high in a comparative example in which the predetermined accompanying data is not used. However, in the present example embodiment, it is possible to prevent the prices of the remaining rooms from being set higher than the appropriate price in such a situation.

In addition, reservation has been described as an example of the action, and it has been described that the demand data does not include the data of the reservation finally canceled by cancellation or the like. However, in the present example embodiment or the first example embodiment, it is possible to perform an application such as determining the canceled reservation data or the group reservation data among the canceled reservation data as the predetermined accompanying data.

### Third Example Embodiment

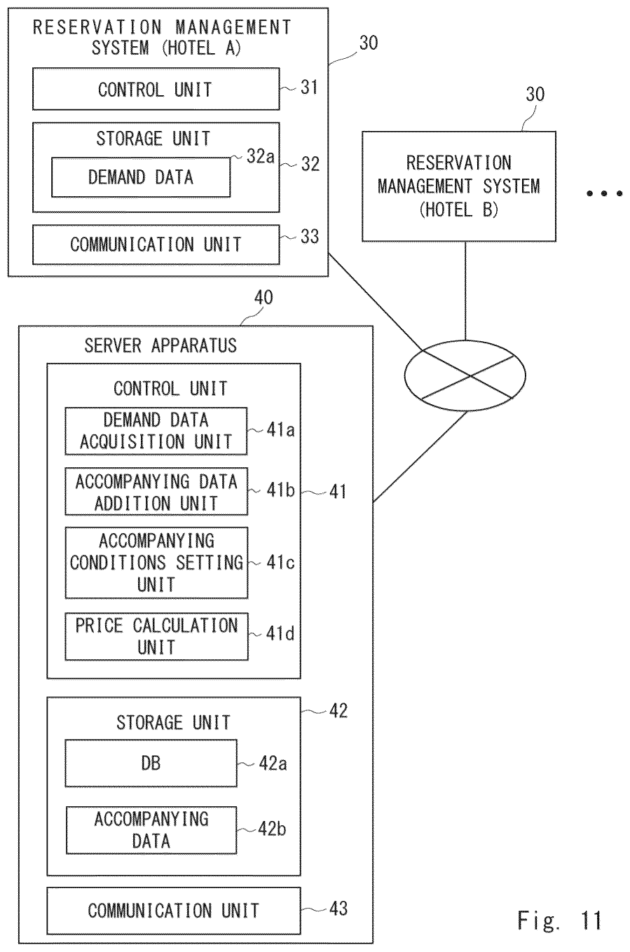

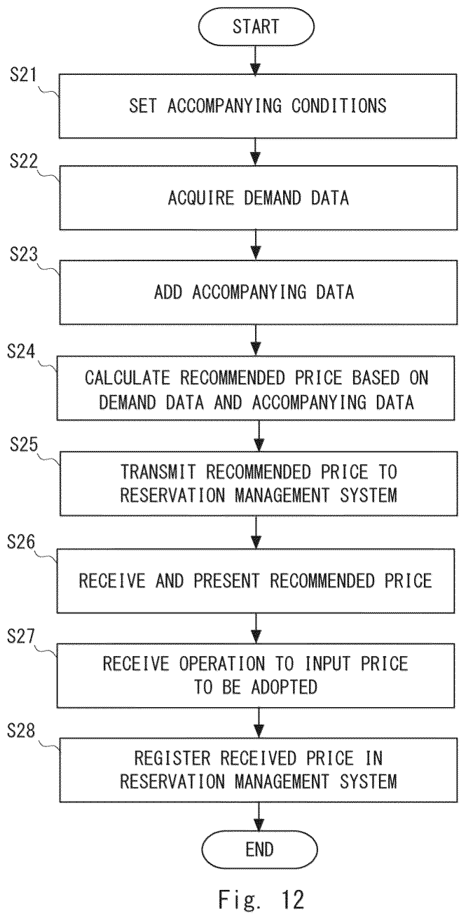

A third example embodiment will be described with reference to FIGS. 11 and 12, focusing on differences from the second example embodiment, but various examples described in the first and second example embodiments can be applied. FIG. 11 is a block diagram illustrating a configuration example of a price setting system according to the third example embodiment.

In the present example embodiment, the distribution of functions in the price setting system is different from that in the second example embodiment. Also in the present example embodiment, similarly to the second example embodiment, an accommodation service of a hotel is taken as an example of the target service, but other types of services can be similarly applied by making a change suitable for the service (for example, a change in definition of action). In addition, also in the present example embodiment, reservation will be described as an example of the action, and in order to simplify the description, it will be described that the demand data does not include the data of the reservation finally canceled by cancellation or the like.

The price setting system (hereinafter, this system) illustrated in FIG. 11 is configured by connecting a reservation management system 30 provided for each hotel and a server apparatus 40 for calculating a price through a network. In addition, the reservation management system 30 can include, for example, a server apparatus that can be browsed, operated, and the like from an installed or portable terminal apparatus in a hotel. The reservation management system 30 is not limited to a single apparatus, and may be configured by apparatuses that are distributed. In addition, by providing the function of the server apparatus 40 in each reservation management system 30, for example, this system can be constructed in each hotel.

The reservation management system 30 can include a control unit 31, a storage unit 32, and a communication unit 33. The control unit 31 is a unit that controls the entire reservation management system 30. Similarly to the control unit 11 in FIG. 3, the control unit 31 can be implemented to include, for example, an IC. For example, the control unit 31 can be implemented by a CPU, a work memory, a non-volatile storage device storing a program, and the like. This program can include a program for causing the CPU to execute processing for general reservation management although detailed description thereof is omitted. Although the description herein will be given on the assumption that demand data 32a is generated by the processing for reservation management, the present invention is not limited thereto. For example, the demand data 32a is acquired by requesting an external apparatus to generate the demand data 32a from the reservation data. In addition, the storage device included in the control unit 31 can also be used as the storage unit 32. The storage unit 32 includes a storage device, and the communication unit 33 can include a communication interface for communicating with the server apparatus 40 through a network.

The control unit 31 performs control to transmit the demand data 32a stored in the storage unit 32 to the server apparatus 40 through the communication unit 33. This control can be performed, for example, in response to a request from the server apparatus 40.

The server apparatus 40 is an apparatus that receives the demand data 32a from the reservation management system 30, calculates a price of an accommodation service, and returns the calculated price to reservation management system 30. Hereinafter, an example in which the server apparatus 40 calculates the price of the accommodation service for the reservation management system 30 of the hotel A will be described, but the server apparatus 40 can individually provide such price calculation processing for each reservation management system 30. However, for example, if a plurality of nearby hotels including the hotel A are managed by one reservation management system 30 and the accommodation services of the plurality of hotels are the same, a common price can be calculated. The server apparatus 40 is not limited to a single apparatus, and may be configured by apparatuses that are distributed.

The server apparatus 40 can include a control unit 41, a storage unit 42, and a communication unit 43. The control unit 41 is a unit that controls the entire server apparatus 40, and can include a demand data acquisition unit 41a, an accompanying data addition unit 41b, an accompanying conditions setting unit 41c, and a price calculation unit 41d. In addition, the server apparatus 40 may not include the accompanying conditions setting unit 41c.

Similarly to the control unit 21 in FIG. 3, the control unit 41 can be implemented to include, for example, an IC. For example, the control unit 41 can be implemented by a CPU, a work memory, a non-volatile storage device storing a program, and the like. This program can be a program for causing the CPU to execute the processing of each of the units 41a to 41d. In addition, the storage device included in the control unit 41 can also be used as the storage unit 42. The storage unit 42 includes a storage device, and the communication unit 43 can include a communication interface for communicating with each reservation management system 30 through a network. In addition, the storage unit 42 includes a DB 42a similar to the DB 22a in the configuration example of FIG. 3, and the DB 42a can be referred to when the price is calculated by the price calculation unit 41d.

The demand data acquisition unit 41a acquires the demand data 32a from the reservation management system 30 through the communication unit 43. The demand data 32a acquired by the demand data acquisition unit 41a can be stored in the storage unit 42, for example. The accompanying data addition unit 41b adds the accompanying data 42b to the demand data 32a, similarly to the accompanying data addition unit 11b in FIG. 3. The accompanying data addition unit 41b can output the demand data 32a to which the accompanying data 42b is added to the price calculation unit 41d as price calculation source data. Alternatively, the accompanying data addition unit 41b can output demand data after removal, which is the demand data 32a reflecting the accompanying data 42b, to the price calculation unit 41d as price calculation source data. The accompanying conditions setting unit 41c sets accompanying conditions similarly to the accompanying conditions setting unit 11c in FIG. 3. However, this setting can be performed by an administrator, a person in charge, or the like on the management side of the server apparatus 40 accessing the server apparatus 40 from the terminal apparatus or the like.

The price calculation unit 41d has the same function as the price calculation unit 21a in FIG. 3. That is, similarly to the price calculation unit 21a, the price calculation unit 41d calculates the price of the accommodation service at a predetermined target time (accommodation target date) based on the demand data 32a and the accompanying data 42b. For example, in an example in which the demand data 32a to which the accompanying data 42b is added as price calculation source data is input by the accompanying data addition unit 41b, the price calculation unit 41d, first, removes data indicating an exceptional demand from the demand data 32a based on the predetermined accompanying data 42b. Then, the price calculation unit 41d calculates the price of the target accommodation service on the predetermined accommodation target date based on the demand data after the removal. In an example in which the demand data after removal, which is the demand data 32a reflecting the accompanying data 42b, is input as price calculation source data by the accompanying data addition unit 41b, the following calculation is performed. That is, the price calculation unit 41d calculates the price of the target accommodation service on the predetermined accommodation target date based on the input demand data after the removal. In any example, the price calculation unit 41d can calculate the price with reference to the DB 42a.

In addition, similarly to the price calculation unit 21a, the price calculation unit 41d can also perform weighting processing on the demand data 32a based on the accompanying data 42b and calculate the price based on the demand data after the weighting processing. In addition, the accompanying conditions setting unit 41c can also set the weighting factor of the weighting processing as a part of the conditions for the information included in the predetermined accompanying data, that is, as a part of the accompanying conditions. In this case, the set weighting factor is used by the price calculation unit 41d to calculate a price subjected to the weighting processing. Also in this case, the price calculation unit 41d can calculate the price with reference to the DB 42a.

Next, a processing example of this system will be described with reference to FIG. 12. FIG. 12 is a flowchart for explaining an example of processing in this system.

First, an administrator of the server apparatus 40, a person in charge of price calculation, or the like sets accompanying conditions using the terminal apparatus, and the accompanying conditions setting unit 41c registers the setting (step S21). The accompanying conditions can include, for example, information indicating whether to add predetermined accompanying data according to the distinction between the group and the individual, whether to add predetermined accompanying data according to the distinction between the foreign customer and the Japanese customer, and the like, and a weighting factor used in the weighting processing. Then, the demand data acquisition unit 41a acquires the demand data 32a from the reservation management system 30 through the communication unit 43 (step S22). Then, the accompanying data addition unit 41b adds the accompanying data 42b to the demand data 32a based on the accompanying conditions (step S23). The accompanying data 42b can be stored in the storage unit 42 in association with the demand data 32a.

Then, the price calculation unit 41d calculates the target date and the price of the plan as a recommended price using this data, that is, the demand data 32a after the accompanying data 42b is added as price calculation source data (step S24). Then, the control unit 41 transmits the calculated price calculated as a recommended price to the reservation management system 30 through the communication unit 43 (step S25).

The control unit 31 of the reservation management system 30 receives the recommended price through the communication unit 33 and stores the recommended price in the storage unit 32, and the recommended price is presented by the reservation management system 30 in a timely manner (step S26). The presentation processing in step S26 can be performed by the control unit 31 of the reservation management system 30 in accordance with, for example, a request from a terminal apparatus used by an administrator, a person in charge of price setting, or the like on the hotel side. In this terminal apparatus, for example, a recommended price or a recommended rank can be presented by a GUI image or the like exemplified in FIG. 8 or 9. Then, the control unit 31 receives an operation such as input of a price to be adopted from the terminal apparatus (step S27), stores the received price in the storage unit 32 to register the received price as a price to be formally applied (step S28), and ends the processing. In addition, the price registered herein is adopted as a price that forms a part of reservation from a customer or future demand data.

According to the present example embodiment, effects similar to those of the second example embodiment are obtained. In addition, according to the present example embodiment, by adding the accompanying data on the management side of the server apparatus 40, the management side of the server apparatus 40 can provide the accompanying data based on a bird's-eye view determination, rather than the hotel side, and can provide a recommended price using this data.

In addition, for example, the accompanying data addition unit 41b can be included in the control unit 31 of the reservation management system 30 instead of being included in the control unit 41, and the server apparatus 40 can receive demand data to which accompanying data is added from the reservation management system 30. In this case, the accompanying conditions setting unit 41c can also be included in the control unit 31 of the reservation management system 30. Alternatively, the accompanying data addition unit 41b can be included in the control unit 41, and the accompanying conditions setting unit 41c can be included in the control unit 31 of the reservation management system 30. In these two configuration examples, the hotel side can set the accompanying conditions. As in the two configuration examples exemplified herein or the configuration example of the second example embodiment, the configuration of function distribution in the system and the server apparatus on the hotel side is not limited to the configuration example of FIG. 11.

### Other Example Embodiments

Although the functions of the price setting system have been described in each example embodiment, the apparatuses included in this system are not limited to the illustrated configuration example, and it is sufficient if these functions can be realized as respective apparatuses.

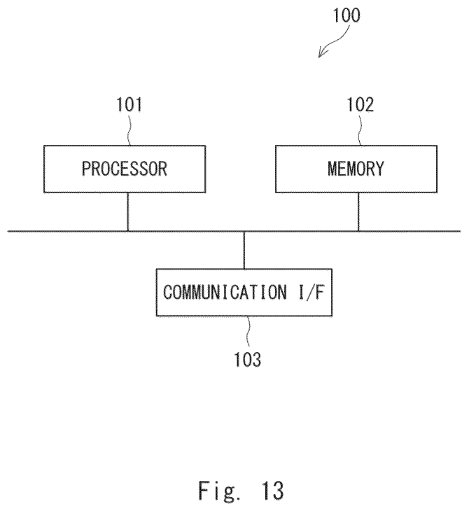

Each apparatus described in the first to third example embodiments may have the following hardware configuration. FIG. 13 is a diagram illustrating an example of the hardware configuration of an apparatus.

An apparatus 100 illustrated in FIG. 13 can include a processor 101, a memory 102, and a communication interface (I/F) 103. The processor 101 may be, for example, a microprocessor, a micro processor unit (MPU), or a CPU. The processor 101 may include a plurality of processors. The memory 102 includes, for example, a combination of a volatile memory and a non-volatile memory. The functions of the respective apparatuses included in the systems described in the first to third example embodiments are realized by the processor 101 reading a program stored in the memory 102 and executing the program. At this time, transmission and reception of information to and from another apparatus can be performed through the communication interface 103 or an input/output interface (not illustrated).

In the above-described example, the program includes a group of commands (or software codes) for causing the computer to perform one or more functions described in the example embodiments, when read by the computer. The program may be stored in a non-transitory computer-readable medium or a tangible storage medium. As an example and not by way of limitation, computer-readable media or tangible storage media include a random-access memory (RAM), a read-only memory (ROM), a flash memory, and a solid-state drive (SSD). In addition, as an example and not by way of limitation, computer-readable media or tangible storage media include other memory technologies, a CD-ROM, a digital versatile disc (DVD), a Blu-ray (registered trademark) disc, or other optical disc storages. In addition, as an example and not by way of limitation, computer-readable media or tangible storage media include a magnetic cassette, a magnetic tape, a magnetic disk storage, or other magnetic storage devices. The program may be transmitted on a transitory computer-readable medium or a communication medium. As an example and not by way of limitation, transitory computer-readable media or the communication media include propagated signals in electrical, optical, acoustic, or any other form.

In addition, the present disclosure is not limited to the above-described example embodiments, and can be appropriately changed without departing from the scope. In addition, the present disclosure may be implemented by appropriately combining the example embodiments.

Some or all of the above-described example embodiments can be described as in the following Supplementary Notes, but are not limited to the following Supplementary Notes.

### (Supplementary Note 1)

A price setting system including:
an input unit configured to receive demand data indicating a demand of a service in time series, the demand data being generated based on data indicating at least one action of reservation, purchase, and payment performed by a customer for the service;
a determination unit configured to determine predetermined accompanying data for the demand data; and
a price setting unit configured to set a price for the service at a predetermined target time based on the demand data and the predetermined accompanying data.

### (Supplementary Note 2)

The price setting system according to Supplementary Note 1, wherein the price setting unit performs weighting processing on the demand data based on the predetermined accompanying data, and sets the price based on the demand data after the weighting processing.

### (Supplementary Note 3)

The price setting system according to Supplementary Note 1 or 2, wherein the predetermined accompanying data includes information about at least one of attributes of a customer, the number of people, and motivation.

### (Supplementary Note 4)

The price setting system according to any one of Supplementary Notes 1 to 3, wherein the predetermined accompanying data includes information indicating whether a customer is a group customer or an individual customer.

### (Supplementary Note 5)

The price setting system according to any one of Supplementary Notes 1 to 3, wherein the predetermined accompanying data includes information indicating whether a customer is a group customer who has suddenly performed the action, a group customer who has non-suddenly performed the action, or an individual customer.

### (Supplementary Note 6)

The price setting system according to any one of Supplementary Notes 1 to 5, wherein
the service is a service for providing a facility or equipment to a customer, and
the predetermined accompanying data includes information indicating a facility or equipment that cannot be provided at the predetermined target time among facilities or equipment to be provided.

### (Supplementary Note 7)

The price setting system according to any one of Supplementary Notes 1 to 6, including: a setting unit configured to set conditions for information to be included in the predetermined accompanying data.

### (Supplementary Note 8)

A price setting method including:
receiving demand data indicating a demand of a service in time series, the demand data being generated based on data indicating at least one action of reservation, purchase, and payment performed by a customer for the service;
determining predetermined accompanying data for the demand data; and
setting a price for the service at a predetermined target time based on the demand data and the predetermined accompanying data.

### (Supplementary Note 9)

The price setting method according to Supplementary Note 8, wherein weighting processing is performed on the demand data based on the predetermined accompanying data, and the price is set based on the demand data after the weighting processing.

### (Supplementary Note 10)

The price setting method according to Supplementary Note 8 or 9, wherein the predetermined accompanying data includes information about at least one of attributes of a customer, the number of people, and motivation.

### (Supplementary Note 11)

The price setting method according to any one of Supplementary Notes 8 to 10, wherein the predetermined accompanying data includes information indicating whether a customer is a group customer or an individual customer.

### (Supplementary Note 12)

The price setting method according to any one of Supplementary Notes 8 to 10, wherein the predetermined accompanying data includes information indicating whether a customer is a group customer who has suddenly performed the action, a group customer who has non-suddenly performed the action, or an individual customer.

### (Supplementary Note 13)

The price setting method according to any one of Supplementary Notes 8 to 12, wherein
the service is a service for providing a facility or equipment to a customer, and
the predetermined accompanying data includes information indicating a facility or equipment that cannot be provided at the predetermined target time among facilities or equipment to be provided.

### (Supplementary Note 14)

The price setting method according to any one of Supplementary Notes 8 to 13, including: processing for setting conditions for information to be included in the predetermined accompanying data.

### (Supplementary Note 15)

A program for causing a computer to execute price setting processing including:
receiving demand data indicating a demand of a service in time series, the demand data being generated based on data indicating at least one action of reservation, purchase, and payment performed by a customer for the service;
determining predetermined accompanying data for the demand data; and
setting a price for the service at a predetermined target time based on the demand data and the predetermined accompanying data.

### (Supplementary Note 16)

The program according to Supplementary Note 15, wherein in the price setting processing, weighting processing is performed on the demand data based on the predetermined accompanying data, and the price is set based on the demand data after the weighting processing.

### (Supplementary Note 17)

The program according to Supplementary Note 15 or 16, wherein the predetermined accompanying data includes information about at least one of attributes of a customer, the number of people, and motivation.

### (Supplementary Note 18)

The program according to any one of Supplementary Notes 15 to 17, wherein the predetermined accompanying data includes information indicating whether a customer is a group customer or an individual customer.

### (Supplementary Note 19)

The program according to any one of Supplementary Notes 15 to 17, wherein the predetermined accompanying data includes information indicating whether a customer is a group customer who has suddenly performed the action, a group customer who has non-suddenly performed the action, or an individual customer.

### (Supplementary Note 20)

The program according to any one of Supplementary Notes 15 to 19, wherein
the service is a service for providing a facility to a customer or equipment, and
the predetermined accompanying data includes information indicating a facility or equipment that cannot be provided at the predetermined target time among facilities or equipment to be provided.

### (Supplementary Note 21)

The program according to any one of Supplementary Notes 15 to 20, wherein the price setting processing includes processing for setting conditions for information to be included in the predetermined accompanying data.

Although the invention of the present application has been described above with reference to the example embodiments, the invention of the present application is not limited to the above. Various modifications that can be understood by those skilled in the art can be made to the configuration and details of the invention of the present application within the scope of the invention.

### REFERENCE SIGNS LIST

1 PRICE SETTING SYSTEM
1a INPUT UNIT
1b DETERMINATION UNIT
1c PRICE SETTING UNIT
10, 30 RESERVATION MANAGEMENT SYSTEM
11, 31 CONTROL UNIT
11a, 41a DEMAND DATA ACQUISITION UNIT
11b, 41b ACCOMPANYING DATA ADDITION UNIT
11c, 41c ACCOMPANYING CONDITIONS SETTING UNIT
12, 32 STORAGE UNIT
12a, 32a DEMAND DATA
12b, 42b ACCOMPANYING DATA
13, 33 COMMUNICATION UNIT
20, 40 SERVER APPARATUS
21, 41 CONTROL UNIT
21a, 41d PRICE CALCULATION UNIT
22, 42 STORAGE UNIT
22a, 42a DB
23, 43 COMMUNICATION UNIT
80, 90 GUI IMAGE
100 APPARATUS
101 PROCESSOR
102 MEMORY
103 COMMUNICATION INTERFACE

What is claimed is:

1. A price setting system comprising:
at least one memory storing instructions; and
at least one processor configured to execute the instructions to do price setting process, wherein the price setting process includes:
receiving demand data indicating a demand of a service in time series, the demand data being generated based on data indicating at least one action of reservation, purchase, and payment performed by a customer for the service;
determining predetermined accompanying data for the demand data; and
setting a price for the service at a predetermined target time based on the demand data and the predetermined accompanying data.

2. The price setting system according to claim 1, wherein the setting includes performing weighting processing on the demand data based on the predetermined accompanying data, and setting the price based on the demand data after the weighting processing.

3. The price setting system according to claim 1, wherein the predetermined accompanying data includes information about at least one of attributes of a customer, the number of people, and motivation.

4. The price setting system according to claim 1, wherein the predetermined accompanying data includes information indicating whether a customer is a group customer or an individual customer.

5. The price setting system according to claim 1, wherein the predetermined accompanying data includes information indicating whether a customer is a group customer who has suddenly performed the action, a group customer who has non-suddenly performed the action, or an individual customer.

6. The price setting system according to claim 1, wherein
the service is a service for providing a facility or equipment to a customer, and
the predetermined accompanying data includes information indicating a facility or equipment that cannot be provided at the predetermined target time among facilities or equipment to be provided.

7. The price setting system according to claim 1, the price setting process includes comprising: a setting unit configured to set conditions for information to be included in the predetermined accompanying data.

8. A price setting method, comprising:
receiving demand data indicating a demand of a service in time series, the demand data being generated based on data indicating at least one action of reservation, purchase, and payment performed by a customer for the service;
determining predetermined accompanying data for the demand data; and
setting a price for the service at a predetermined target time based on the demand data and the predetermined accompanying data.

9. The price setting method according to claim 8, wherein weighting processing is performed on the demand data based on the predetermined accompanying data, and the price is set based on the demand data after the weighting processing.

10. The price setting method according to claim 8, wherein the predetermined accompanying data includes information about at least one of attributes of a customer, the number of people, and motivation.

11. The price setting method according to claim 8, wherein the predetermined accompanying data includes information indicating whether a customer is a group customer or an individual customer.

12. The price setting method according to claim 8, wherein the predetermined accompanying data includes information indicating whether a customer is a group customer who has suddenly performed the action, a group customer who has non-suddenly performed the action, or an individual customer.

13. The price setting method according to claim 8, wherein
the service is a service for providing a facility or equipment to a customer, and
the predetermined accompanying data includes information indicating a facility or equipment that cannot be provided at the predetermined target time among facilities or equipment to be provided.

14. The price setting method according to claim 8, comprising: processing for setting conditions for information to be included in the predetermined accompanying data.

15. A non-transitory computer-readable medium storing a program for causing a computer to execute price setting processing including:
receiving demand data indicating a demand of a service in time series, the demand data being generated based on data indicating at least one action of reservation, purchase, and payment performed by a customer for the service;
determining predetermined accompanying data for the demand data; and
setting a price for the service at a predetermined target time based on the demand data and the predetermined accompanying data.

16. The non-transitory computer-readable medium according to claim 15, wherein in the price setting processing, weighting processing is performed on the demand data based on the predetermined accompanying data, and the price is set based on the demand data after the weighting processing.

17. The non-transitory computer-readable medium according to claim 15, wherein the predetermined accompanying data includes information about at least one of attributes of a customer, the number of people, and motivation.

18. The non-transitory computer-readable medium according to claim 15, wherein the predetermined accompanying data includes information indicating whether a customer is a group customer or an individual customer.

19. The non-transitory computer-readable medium according to claim 15, wherein the predetermined accompanying data includes information indicating whether a customer is a group customer who has suddenly performed the action, a group customer who has non-suddenly performed the action, or an individual customer.

20. The non-transitory computer-readable medium according to claim 15, wherein
the service is a service for providing a facility or equipment to a customer, and
the predetermined accompanying data includes information indicating a facility or equipment that cannot be provided at the predetermined target time among facilities or equipment to be provided.

21. (canceled)
